(19) United States
(12) Patent Application Publication
(10) Pub. No.: US 2021/0189765 A1
(43) Pub. Date: Jun. 24, 2021

(54) Key Handle Assembly

(71) Applicant: David Joshlin, Sherwood, AR (US)

(72) Inventor: David Joshlin, Sherwood, AR (US)

(21) Appl. No.: 16/722,153

(22) Filed: Dec. 20, 2019

(51) Int. Cl. E05B 19/00

(52) U.S. Cl. CPC E05B 19/0082

(57) ABSTRACT

A key handle assembly for improving key usability for persons having limited dexterity includes a body. The body has a first side, a second side, and a perimeter edge extending between the first and second sides. The perimeter edge has a top edge, a bottom edge, a front edge and a rear edge. The front edge of the body has a plurality of notches extending therein and toward the rear side, and through the top and bottom edges. Each of the notches receives a key pivotably through the body. A plurality of intermediate walls is defined on opposite sides of the notches. The body has an aperture extending into the first side and through each of the intermediate walls. A rod extends through the aperture, through each of the intermediate walls and through a key hole in the key such that the key is pivotably coupled to the body.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to key holder devices and more particularly pertains to a new key holder device for improving key usability for persons having limited dexterity. The disclosed invention provides a user with an enlarged handle which is pivotable to provide improved operability for persons having limited dexterity and grip strength when locking and unlocking a door.

### (2) Description of Related Art Including Information Disclosed Under 37 CFR 1.97 and 1.98

The prior art relates to key holder devices. Prior disclosures being silent on a device which holds traditional keys and allows variable handle positions to aid in rotation of the key for persons having limited dexterity and grip strength.

### BRIEF SUMMARY OF THE INVENTION

An embodiment of the disclosure meets the needs presented above by generally comprising a body. The body has a first side, a second side, and a perimeter edge extending between the first side and a second side. The perimeter edge has a top edge, a bottom edge, a front edge and a rear edge. The front edge of the body has a plurality of notches extending therein and toward the rear side. Each of the notches extends through the top and bottom edges. Each of the notches has a width configured to receive a key and a depth configured to allow the key to pivot through the body. A plurality of intermediate walls is defined on opposite sides of the notches. The body has an aperture extending therethrough. The aperture extends into the first side and through each of the intermediate walls. A rod extends through the aperture in the first side and through each of the intermediate walls. The rod is configured to be extendable through a key hole in the key such that the key is pivotably coupled to the body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a key handle assembly according to an embodiment of the disclosure.

FIG. 2 is a front top isometric view of an embodiment of the disclosure.

FIG. 3 is a front bottom isometric view of an embodiment of the disclosure.

FIG. 4 is a side view of an embodiment of the disclosure.

FIG. 5 is a cross-sectional view of an embodiment of the disclosure taken along line 5-5 in FIG. 4.

FIG. 6 is an in-use view of an embodiment of the disclosure.

### DETAILED DESCRIPTION OF THE INVENTION

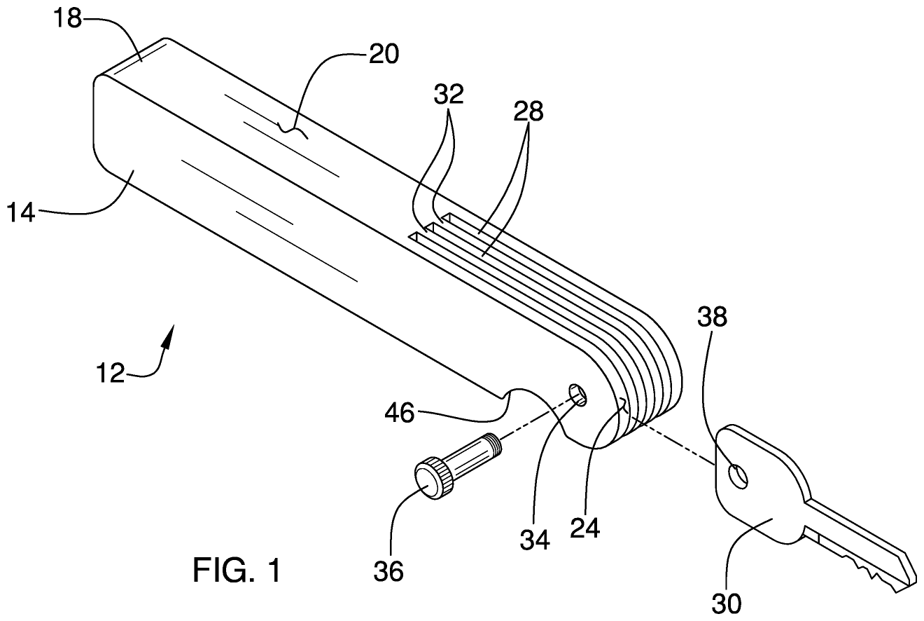

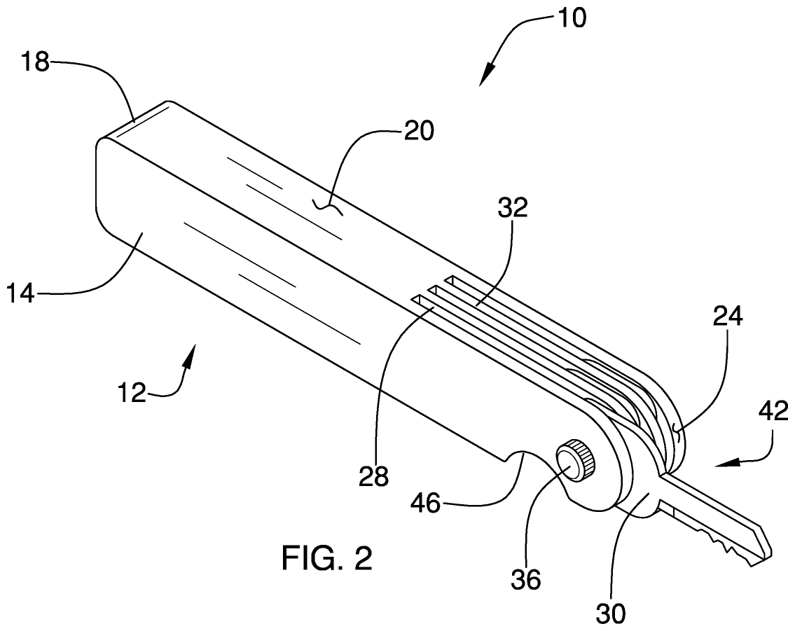

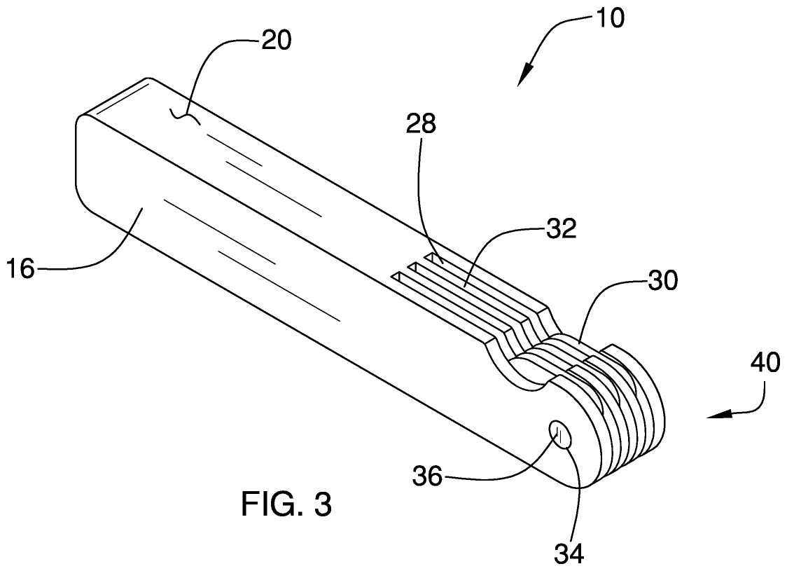

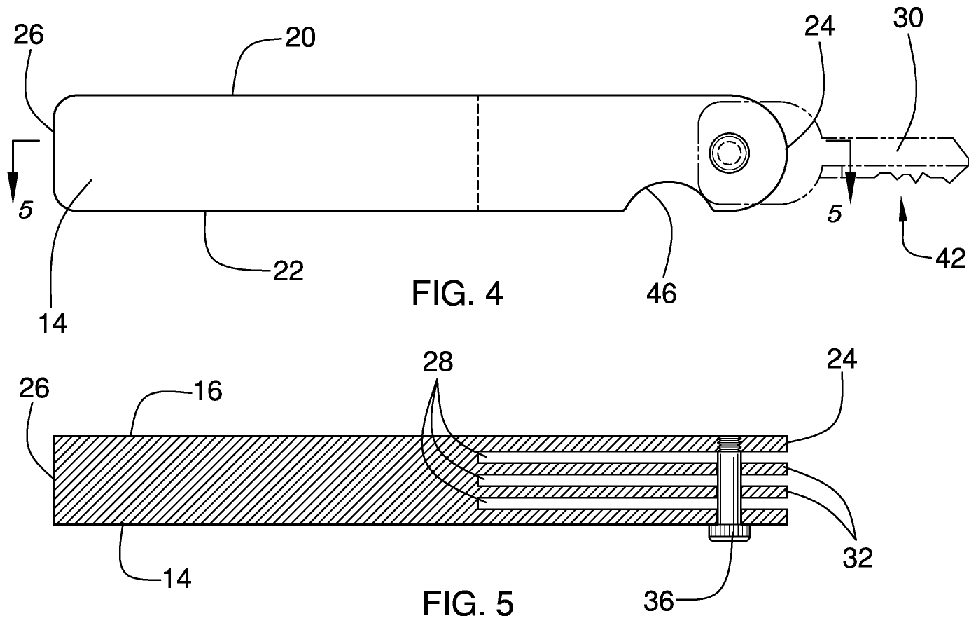

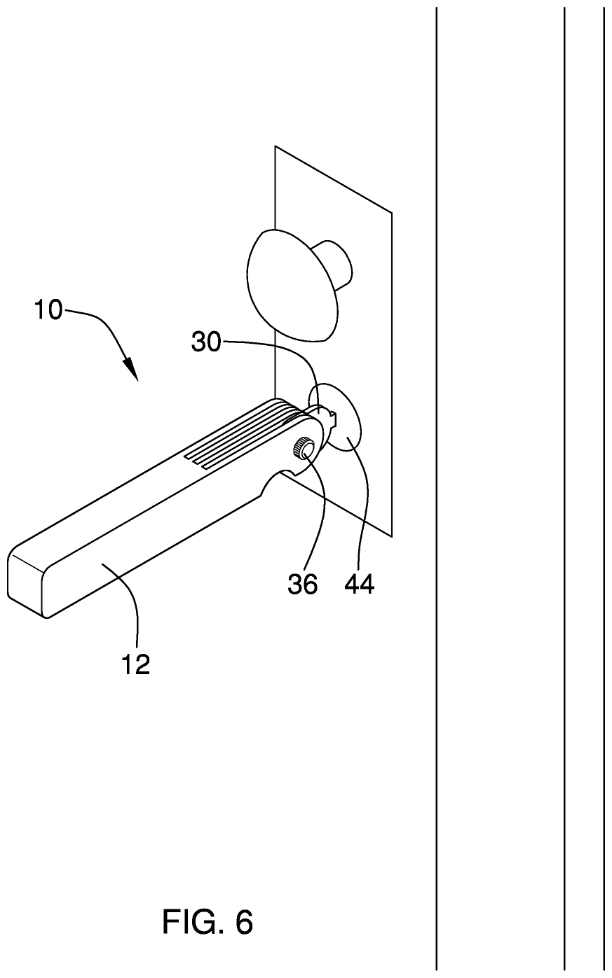

With reference now to the drawings, and in particular to FIGS. 1 through 6 thereof, a new key holder device embodying the principles and concepts of an embodiment of the disclosure and generally designated by the reference numeral 10 will be described.

As best illustrated in FIGS. 1 through 6, the key handle assembly 10 generally comprises a body 12. The body 12 has a first side 14, a second side 16, and a perimeter edge 18 extending between the first side 12 and a second side 16. The perimeter edge 18 has a top edge 20, a bottom edge 22, a front edge 24 and a rear edge 26. The first side 14 and the second side 16 are positioned opposite each other at a distance between 0.50 inch and 2.00 inches apart. The front edge 24 and the rear edge 26 are positioned opposite each other at a distance between 6.00 inches and 10.00 inches.

The front edge 24 of the body 12 has a plurality of notches 28 extending therein and toward the rear side 26. Each of the notches 28 extends through the top edge 20 and the bottom edge 22. Each of the notches 28 has a width configured to receive a key 30. Each of the notches 28 has a depth configured to allow the key 30 to pivot through the body 12. A plurality of intermediate walls 32 is defined on opposite sides of the notches 28. The body 12 has an aperture 34 extending therethrough. The aperture 34 extends into the first side 14 and through each of the intermediate walls 32. The aperture 34 is positioned between the top edge 20 and the bottom edge 22 and is positioned adjacent to the front edge 24. The aperture 34 may extend through the second side 16.

A rod 36 extends through the aperture 34 in the first side 14 and through each of the intermediate walls 32. The rod 36 releasably engages the body 12 adjacent to the second side 16. The rod 36 is configured to be extendable through a key hole 38 in the key 30 such that the key 30 is pivotably coupled to the body 12. The key 30 is positionable in a stored position 40 extending toward the rear edge 26 or in an extended position 42 extending away from the front edge 24. The rod 36 may extend through the second side 16. The rod 36 may be releasably fastened with a fastener positioned to abut the second side 16. The rod 36 is releasably engaged to the body 12 using any conventional method of removable attachment, which may include threads, friction fittings, or pins.

The body 12 may be orientated in a multitude of alternative positions between the stored position 40 and extended position 42 wherein the key 30 is still insertable into a lock 44. Potential alternative positions include the body 12 being perpendicular to the key 30 or at any angle between perpendicular and the extended position 42. A person should position the body 12 in whichever position is best suited to rotate the key 30 and the body 12 when addressing any limitations to dexterity or grip strength.

The bottom edge 22 has a recess 46 extending therein and extending through each of the first side 14 and the second side 16. The recess 46 extends into the notches 28 and is configured to provide access to the key 30 when the key 30 is in the stored position 40.

In use, the key 30 is pivoted from the stored position 40 to the extended position 42. The key 30 is inserted into the lock 44. The body 12 is rotated to engage or disengage the lock 44. The key 30 is removed from the lock 44. The key 30 is pivoted into the body 12 to rest in the stored position 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A key handle assembly being configured to facilitate inserting a key into a lock for persons having dexterity limitations, said assembly comprising:
a body having a first side, a second side, and a perimeter edge extending between said first side and a second side, said perimeter edge having a top edge, a bottom edge, a front edge and a rear edge;
said front edge of said body having a plurality of notches extending therein and toward said rear side, each of said notches extending through said top and bottom edges, said notches each having a width configured to receive the key, said notches each having a depth configured to allow the key to pivot through said body;
a plurality of intermediate walls being defined on opposite sides of said notches;
said body having an aperture extending therethrough, said aperture extending into said first side and through each of said intermediate walls; and
a rod extending through said aperture in said first side and through each of said intermediate walls, said rod being configured to be extendable through a key hole in the key such that the key is pivotably coupled to said body.

2. The key handle assembly according to claim 1, wherein said first side and said second side are positioned opposite each other at a distance between 0.50 inch and 2.00 inches apart.

3. The key handle assembly according to claim 1, wherein said front edge and said rear edge are positioned opposite each other at a distance between 6.00 inches and 10.00 inches apart.

4. The key handle assembly according to claim 1, wherein said aperture is positioned between said top edge and said bottom edge, said aperture being positioned adjacent to said front edge.

5. The key handle assembly according to claim 1, wherein said rod releasably engages said body adjacent to said second side.

6. The key handle assembly according to claim 1, wherein the key is positionable in a stored position extending toward said rear edge or in an extended position extending away from said front edge.

7. The key handle assembly according to claim 1, wherein said bottom edge has a recess extending therein and extending through each of said first and second sides, said recess extending into said notches.

8. The key handle assembly according to claim 6, wherein said bottom edge has a recess extending therein and extending through each of said first and second sides, said recess extending into said notches, said recess being configured to provide access to the key when the key is in said stored position.

9. A key handle assembly being configured to facilitate inserting a key into a lock for persons having dexterity limitations, said assembly comprising:
a body having a first side, a second side, and a perimeter edge extending between said first side and a second side, said perimeter edge having a top edge, a bottom edge, a front edge and a rear edge, said first side and said second side being positioned opposite each other at a distance between 0.50 inch and 2.00 inches apart, said front edge and said rear edge being positioned opposite each other at a distance between 6.00 inches and 10.00 inches;
said front edge of said body having a plurality of notches extending therein and toward said rear side, each of said notches extending through said top and bottom edges, said notches each having a width configured to receive the key, said notches each having a depth configured to allow the key to pivot through said body;
a plurality of intermediate walls being defined on opposite sides of said notches;
said body having an aperture extending therethrough, said aperture extending into said first side and through each of said intermediate walls, said aperture being positioned between said top edge and said bottom edge, said aperture being positioned adjacent to said front edge;
a rod extending through said aperture in said first side and through each of said intermediate walls, said rod releasably engaging said body adjacent to said second side, said rod being configured to be extendable through a key hole in the key such that the key is pivotably coupled to said body, wherein the key is positionable in a stored position extending toward said rear edge or in an extended position extending away from said front edge; and
said bottom edge having a recess extending therein and extending through each of said first and second sides, said recess extending into said notches, said recess being configured to provide access to the key when the key is in said stored position.
